(19) United States
(12) Patent Application Publication
(10) Pub. No.: US 2026/0195167 A1
(43) Pub. Date: Jul. 9, 2026

(54) APPARATUS COMPRISING INTERRUPT TRACKING CIRCUITRY

(71) Applicant: Arm Limited, Cambridge (GB)

(72) Inventors: Timothy Nicholas Hay, Cambridge (GB); Christoffer Dall, Copenhagen (DK); Martin Weidmann, Suffolk (GB)

(73) Assignee: Arm Limited, Cambridge (GB)

(21) Appl. No.: 19/128,704

(22) PCT Filed: Oct. 6, 2023
(86) PCT No.: PCT/GB2023/052592

§ 371 Date: May 9, 2025

(30) Foreign Application Priority Data
Nov. 15, 2022 (GB) 2217011.2

(51) Int. Cl. G06F 9/48; G06F 16/901

(52) U.S. Cl. CPC G06F 9/4818; G06F 16/9024

(57) ABSTRACT

An apparatus (10) and a method are provided, wherein the apparatus comprises interrupt detection circuitry (40) which detects interrupts raised by at least one interrupt source (14), and interrupt tracking circuitry (44) which manages one or more hard-ware-managed linked list data structures to track pending interrupts detected by the interrupt detection circuitry. A computer program comprising computer-readable code for fabrication of the apparatus, and a computer-readable storage medium are also provided.

The present technique relates to the field of data processing.

An interrupt controller in a data processing system detects interrupts raised by one or more interrupt sources, and signals the detected interrupts to a processor responsible for handling the interrupt.

Viewed from an example of the present technique, there is provided an apparatus comprising:
interrupt detection circuitry to detect interrupts raised by at least one interrupt source; and
interrupt tracking circuitry to manage one or more hardware-managed linked list data structures to track pending interrupts detected by the interrupt detection circuitry.

Viewed from another example of the present technique, there is provided a system comprising:
the apparatus described above;
interconnect circuitry coupled to the apparatus; and
at least one processing element coupled to the interconnect circuitry.

Viewed from another example of the present technique, there is provided a method comprising:
detecting, using the interrupt detection circuitry, interrupts raised by at least one interrupt source; and
managing, in hardware, one or more linked list data structures to track pending interrupts detected by the interrupt detection circuitry.

Viewed from another example of the present technique, there is provided a computer program comprising computer-readable code for fabrication of an apparatus comprising:
interrupt detection circuitry to detect interrupts raised by at least one interrupt source; and
interrupt tracking circuitry to manage one or more hardware-managed linked list data structures to track pending interrupts detected by the interrupt detection circuitry.

Viewed from another example of the present technique, there is provided a computer-readable storage medium to store the computer program described above.

Further aspects, features and advantages of the present technique will be apparent from the following description of examples, which is to be read in conjunction with the accompanying drawings, in which:

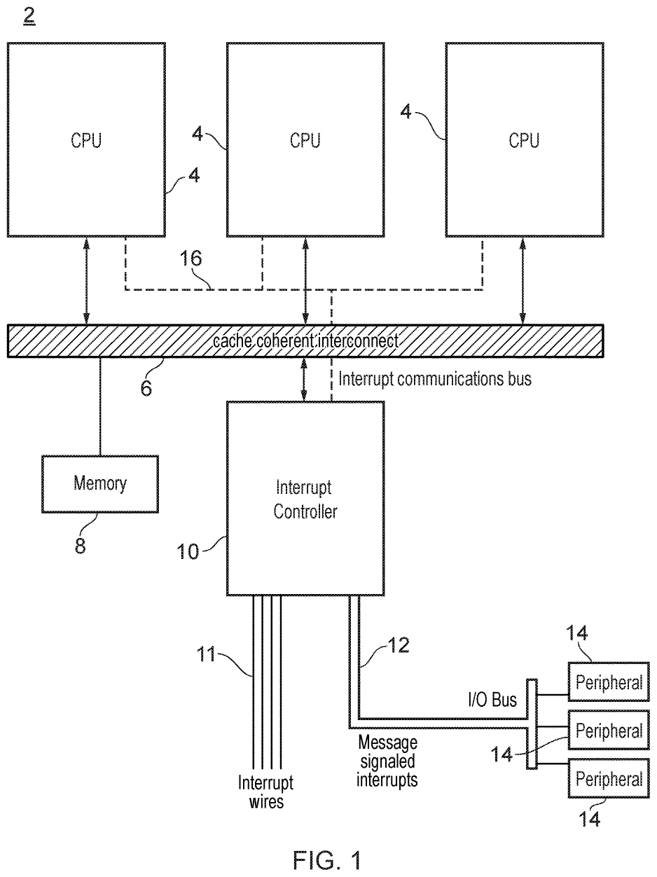

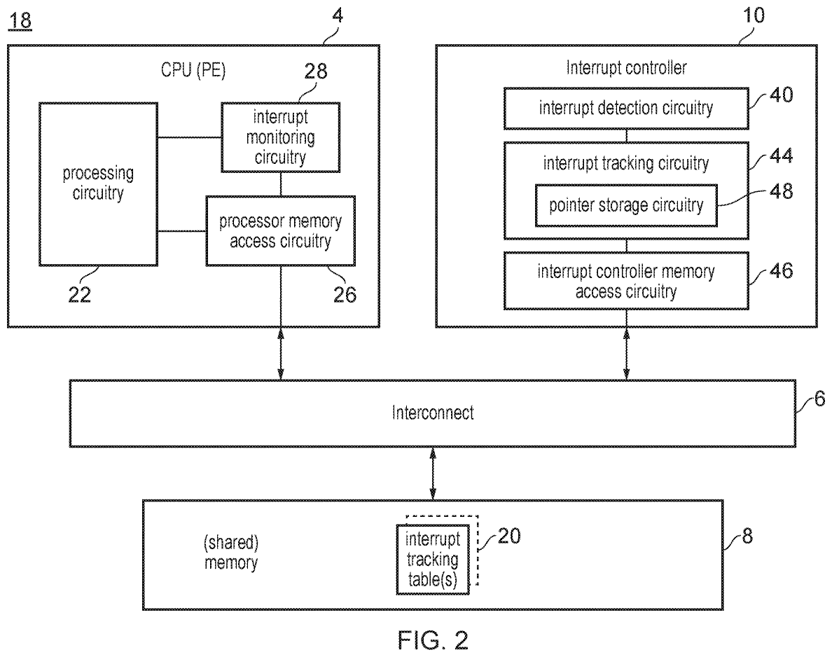

FIGS. 1 and 2 show examples of a data processing system in which one or more CPUs are coupled to an interrupt controller and memory via an interconnect;

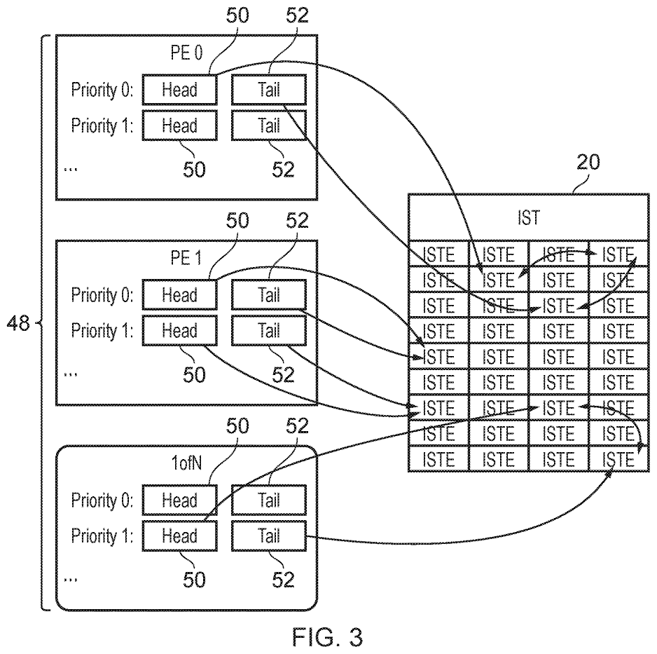

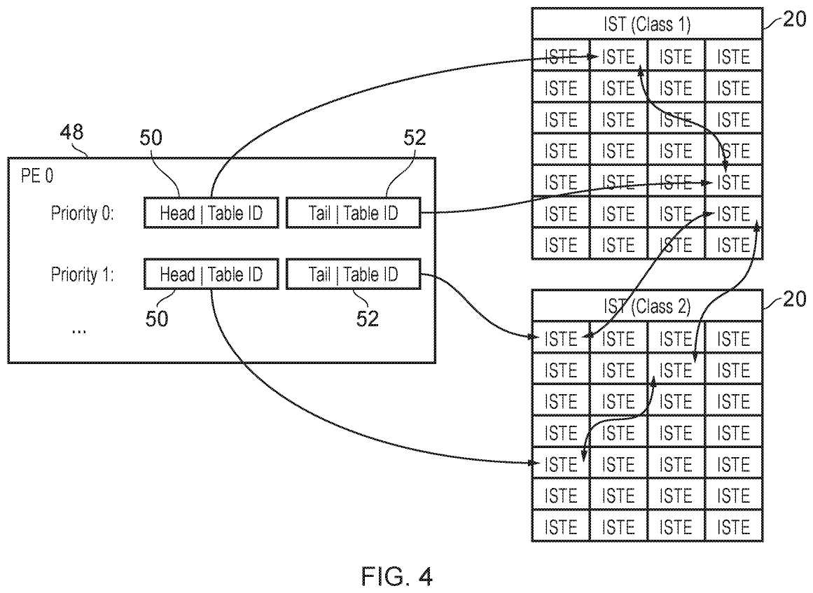

FIGS. 3 and 4 show how head and tail pointers managed by interrupt tracking circuitry can be used to track pending interrupts in a linked list data structure;

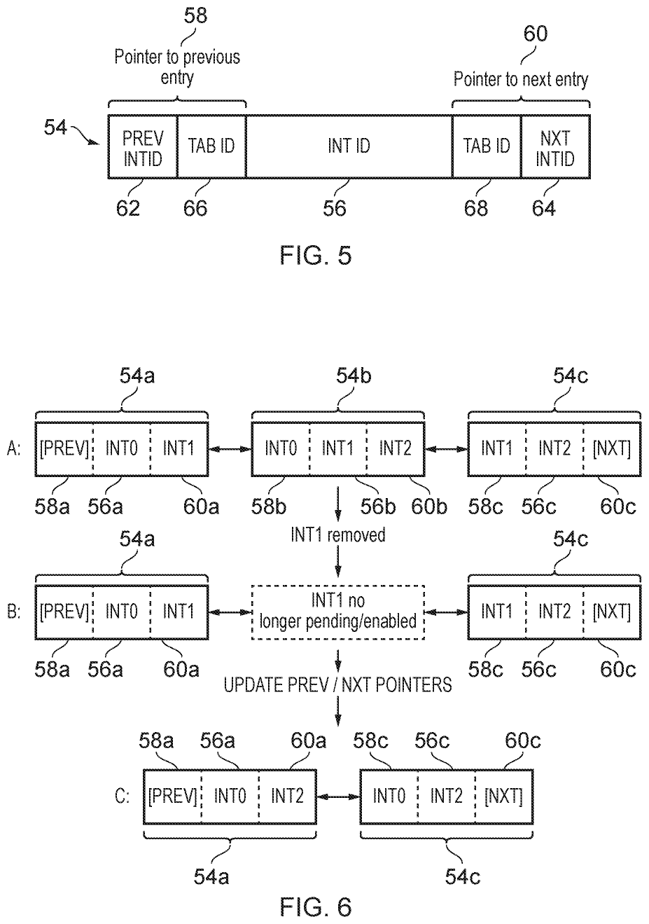

FIG. 5 shows an example of an entry in a hardware-managed linked list data structure;

FIG. 6 illustrates how an entry can be removed from a doubly-linked list;

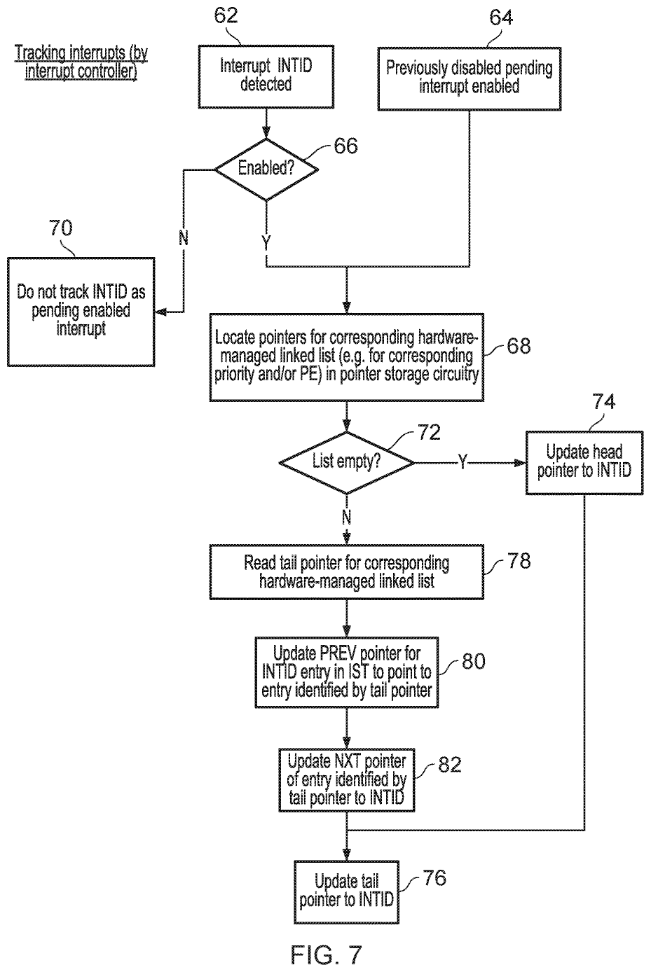

FIG. 7 is a flow diagram showing tracking of interrupts by an interrupt controller;

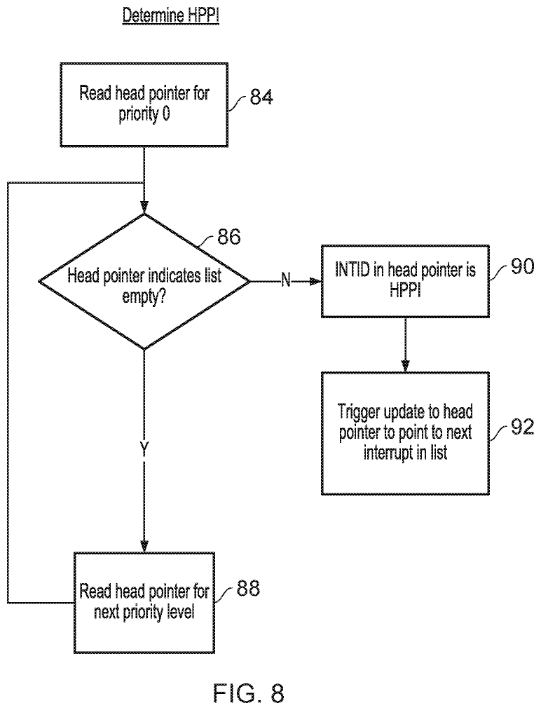

FIG. 8 is a flow diagram showing a process for identifying a highest priority pending interrupt (HPPI); and

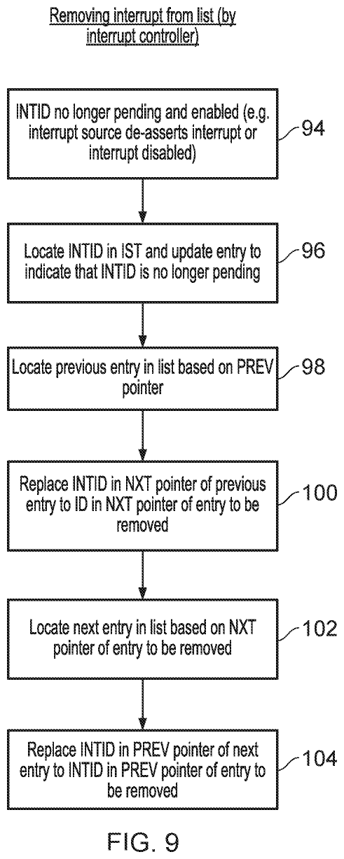

FIG. 9 is a flow diagram showing removal of an interrupt from a doubly-linked list.

Before discussing example implementations with reference to the accompanying figures, the following description of example implementations and associated advantages is provided.

In accordance with one example configuration there is provided an apparatus, comprising interrupt detection circuitry to detect interrupts raised by at least one interrupt source, and interrupt tracking circuitry to manage one or more hardware-managed linked list data structures to track pending interrupts detected by the interrupt detection circuitry.

The apparatus (which could, for example, be an interrupt controller (interrupt control circuitry)) is responsible for detecting interrupts raised by one or more interrupt sources (e.g. these could be peripherals), and may further be responsible for signalling interrupts to processors (both virtual and physical) responsible for handling the interrupts. An interrupt may be a request to interrupt currently executing code to process/respond to a particular event. For example, an interrupt may be used by hardware devices (e.g. peripherals) to indicate electronic or physical state changes that require time-sensitive attention. Interrupts may also be used to implement computer multitasking, especially in real-time computing.

An interrupt controller may maintain one or more interrupt tracking structures (e.g. in storage circuitry such as memory) that hold information about interrupts which are currently pending. These data structures may be made available to processors responsible for handling interrupts, to provide information about the interrupts to the processors. However, as the number of processors and the number of interrupts increases, the size of these interrupt tracking data structures also increases. For example, interrupt tracking structures could comprise large arrays of bits, indicating the pending and enabled states for a large number of interrupts. In such implementations, identifying pending interrupts that need to be dealt with by a processor—e.g. determining the highest priority pending interrupt (HPPI)—requires scanning these large arrays of bits. This can be a time consuming process, and can lead to reduced performance and increased implementation cost for interrupt controllers.

The present technique provides an improved approach. In particular, the apparatus of the present technique is arranged to track the pending (e.g. not yet resolved) interrupts in tracking structures that take the form of hardware-managed linked lists. A linked list is an ordered list of entries (in this case, entries identifying pending interrupts), in which each entry points to the next entry in the list. A linked list can, therefore, be traversed using these next pointers, without needing to scan a large array of data to identify each entry. Hence, tracking the pending interrupts in a linked list can allow a processor, the interrupt controller or other circuitry to quickly identify the next pending interrupt in a given order, without needing to scan through a large interrupt tracking structure.

The linked list data structures provided by the present technique are hardware-managed—in particular, they are managed by the interrupt tracking circuitry, which is hardware within the apparatus. This means that the management of the linked lists can be performed centrally, by the apparatus itself, without relying on processing circuitry within one or more processors in the system executing software to manage the linked lists.

Hence, the present technique provides an approach to tracking interrupts, in hardware, that reduces the performance cost associated with tracking interrupts, and which is scalable to systems with varying numbers of processors and varying numbers of interrupts.

The present technique can be particularly advantageous in systems with large numbers of interrupts, since the number of interrupts in a given linked list can be significantly smaller than the total number of interrupts. For example, if interrupt tracking tables are used to track pending interrupts, the number of entries in the interrupt tracking tables may be significantly larger than the number of entries in any given linked list, and therefore any long-running search operation is avoided.

In some examples, the interrupt tracking circuitry comprises pointer storage circuitry to store, for each of the one or more hardware-managed linked list data structures, a head pointer indicative of a first entry in the hardware-managed linked list data structure and a tail pointer indicative of a last entry in the hardware-managed linked list data structure.

There are a number of ways in which the one or more hardware-managed linked list data structures (also referred to herein as “hardware-managed linked lists” or simply “linked lists”) can be implemented in the present technique. In a particular example, the linked lists may be implemented using “head” and “tail” pointers maintained in pointer storage circuitry (provided in hardware) in the apparatus. In particular, a head pointer identifies the first entry (also referred to as the head entry) in a given linked list and the tail pointer identifies the last entry (also referred to as the tail entry) in the given linked list—if a plurality of linked lists is provided, a head pointer and a tail pointer may be provided for each linked list.

A head pointer provides a simple and effective way of identifying the next pending interrupt in a given linked list (for example when determining which interrupt should be dealt with next by a given processor—the head pointer identifies the next interrupt in the linked list), without needing to scan through an entire array of data in a storage structure such as system memory. This, therefore, avoids the performance and energy costs associated with scanning a large array of data. Similarly, providing a tail pointer makes it easy to locate the end of the list (e.g. the tail pointer identifies the end of the list), for example when adding another interrupt to the end of the list. Providing head and tail pointers in this way can also clearly indicate when a given list is empty—for example, when the head pointer for a given linked list indicates that the linked list is empty (e.g. if it is invalid), this could be interpreted as indicating that there are no pending interrupts in the liked list. Checking one pointer to determine whether any interrupts are pending incurs a far lower performance cost than scanning through an entire array in memory, just to find that none of the represented interrupts are pending.

In some examples, the one or more hardware-managed linked list data structures comprise at least one physical interrupt linked list to track physical interrupts and at least one virtual interrupt linked list to track virtual interrupts, and the interrupt tracking circuitry comprises memory access circuitry to maintain, in a memory accessible to the interrupt controller, a pointer data structure to store, for each of the at least one virtual interrupt linked list, a head pointer indicative of a first entry in the hardware-managed linked list data structure and a tail pointer indicative of a last entry in the hardware-managed linked list data structure.

Hence, head and tail pointers for one or more virtual interrupt linked lists could be stored in shared memory (e.g. as opposed to being stored in pointer storage circuitry, as in the example above). This supports storing the state for a scalable number of virtual machines (VMs) in addition to the physical interrupts (where the head/tail pointers may, for example, be stored in the pointer storage circuitry in the interrupt controller).

In some examples, the interrupt tracking circuitry is responsive to identifying a given interrupt to be tracked to:
i) update a next entry pointer in the last entry in a given hardware-managed linked list data structure to point to an entry corresponding to the given interrupt; and
ii) update the tail pointer for the given one of the one or more hardware-managed linked list data structures to indicate the entry corresponding to the given interrupt.

Note that steps (i) and (ii) can be performed in any order, and can either be performed in parallel or one after the other. Further, it should be noted that identifying a given interrupt to be tracked may, in some implementations, refer to one or both of the interrupt detection circuitry detecting an interrupt (particularly an enabled interrupt) and the interrupt tracking circuitry determining that a previously disabled interrupt has become enabled.

In this example, the tail pointer maintained in hardware for a particular linked list is used to add an interrupt to the list of pending interrupts to be tracked, allowing a first-in-first-out (FIFO) scheme to be supported, which avoids starvation of interrupts in a given list (e.g. one could simply use the head pointer to both identify the next interrupt to be serviced and identify the position at which to insert further interrupts to be tracked; however, this can lead to starvation of interrupts).

In some examples, the pointer storage circuitry is configured to store, as the head pointer for each of the one or more hardware-managed linked list data structures, an interrupt identifier associated with an interrupt represented by the first entry of the hardware-managed linked list data structure and to store, as the tail pointer for each of the one or more hardware-managed linked list data structures, an interrupt identifier associated with an interrupt represented by the last entry of the hardware-managed linked list data structure.

In some implementations, the head and tail pointers stored in the pointer storage circuitry could take the form of address pointers—for example, the head and tail pointers could identify the head and tail entries of a given linked list by indicating addresses at which those entries are stored. However, in this example the head and tail pointers comprise interrupt identifiers. In particular, the head pointer for a given linked list is an interrupt identifier for the interrupt at the head of the linked list, and the tail pointer for the given linked list is an interrupt identifier for the interrupt at the tail of the linked list (unless the linked list is empty, in which case the head and tail pointers may store some default value to indicate that the list is empty).

Using interrupt identifiers, instead of address pointers, as the head and tail pointers allows the pointers to remain valid (and hence not need to be updated) across virtualisation and address translation boundaries, as well as across physical machine boundaries, e.g. in the context of virtual machine (VM) migration—this is due to the interrupt identifier remaining the same, regardless of the physical and/or virtual address of the location at which the head and tail entries of the list are saved. For example, if a linked list data structure is moved from one area of memory to another (e.g. as a virtual machine is migrated from one CPU to another, for example), the physical addresses for each of the entries in the linked list will be updated, but the interrupt identifiers will not necessarily be updated. Similarly, if the address translation for one or more entries changes (e.g. the virtual address changes), the interrupt identifiers will not necessarily change. Hence, using interrupt identifiers as the head and tail pointers allows the pointers to remain valid despite changes to physical or virtual addresses of the entries.

In examples such as this, the interrupt tracking circuitry may have a scheme for mapping the interrupt identifier to an address in memory (or other storage circuitry) at which the corresponding entry is stored—e.g. this could involve calculating, based on the interrupt identifier or a portion of the interrupt identifier, an offset relative to a base address. Also, note that any pointers within a given entry in a linked list (as discussed below, these could include e.g. pointers to the next and, optionally, previous entries in the list) could also be represented as interrupt identifiers.

In some examples, the interrupt tracking circuitry is configured to identify one of a plurality of priority levels associated with each pending interrupt, and manage, for each of the plurality of priority levels, a corresponding hardware-managed linked list data structure to track pending interrupts associated with that priority level.

Different interrupts may be associated with different priority levels or levels of importance. In this example, a linked list is maintained for each of multiple priority levels of the pending interrupts. This simplifies the process for inserting a new interrupt into the tracking structure. For example, while one could provide a single linked list identifying pending interrupts from multiple priority levels, ordered according to their priority levels (e.g. with the highest priority pending interrupt (HPPI) at the head of the list), adding a newly pending interrupt with a given priority level to such a list would require searching through the list to find the right position to insert the interrupt, based on its priority. In contrast, providing a separate linked list for each of the different priority levels can simplify inserting a newly pending interrupt.

However, it will be appreciated that in alternative implementations, a single linked list could be provided to track all pending interrupts. This could be suitable if, for example, there is only one priority level or level of importance, or if the number of pending interrupts to be tracked is small.

In some examples, the interrupt tracking circuitry is configured to identify, in each entry of a given hardware-managed linked list data structure other than a last entry, a next entry in the given hardware-managed linked list data structure.

Hence, a hardware-managed linked list data structure (linked list) may be a list of entries in which any given entry other than the last entry points to the next entry in the linked list.

In some examples, the interrupt tracking circuitry is configured to manage the one or more hardware-managed linked list data structures as doubly-linked lists, wherein each entry in a given hardware-managed linked list data structure other than a first entry and a last entry indicates the next entry in the hardware-managed linked list data structure and the preceding entry in the hardware-managed linked list data structure.

The linked lists used in the present technique can, in some examples, be provided as singly-linked lists (e.g. linked lists wherein each entry other than the last entry identifies the next entry, but does not identify the previous entry). However, it can be particularly advantageous to implement the linked lists as doubly-linked lists (e.g. linked lists wherein each entry other than the first and last entries identifies both the next entry and the preceding entry in the linked list). In particular, when a doubly-linked list is used, this can simplify the “healing” of the list after an entry is removed. For example, when an entry is removed (e.g. when an interrupt is no longer pending and enabled), the entries to either side of the removed entry can be identified based on the next and previous pointers in that entry, and the list can be healed by updating the pointers in those identified entries. Hence, a doubly-linked list, can be “healed” following the removal of an entry without needing to fully scan through interrupt tracking structures. In addition, an implementation that uses doubly-linked lists in this way can be robust against a malformed list, by trivially detecting loops in the list which would otherwise require some form of a pointer chasing (e.g. hare and tortoise) algorithm.

In some examples, the interrupt tracking circuitry is responsive to determining that a given interrupt is no longer pending to remove, from the one or more hardware-managed linked list data structures, an entry representing the given interrupt, wherein removing the entry representing the given interrupt comprises updating the preceding entry in the hardware-managed linked list data structure to point to the entry following the entry that was removed from the hardware-managed linked list data structure.

In this way, a hardware-managed linked list data structure can be updated after an entry is removed, such that the list structure and ordering is maintained. Note that the above process is applicable to removing an entry from a singly-linked list or from a doubly-linked list—for example, in a singly-linked list, removal of an entry from a single-linked list may be possible simply by updating the preceding entry to point to the entry following the removed entry. However, note that in a singly-linked list, you might have to traverse the list from the beginning to find the entry that points to the deleted entry.

Note that, if the entry is removed from the head or the tail of the linked list (or, indeed, if an entry is added to the head or tail of the linked list) it may also be necessary to update head and tail pointers for the linked list, where head and tail pointers are provided.

In some examples, the interrupt tracking circuitry is configured to manage the one or more hardware-managed linked list data structures as doubly linked lists, wherein each entry in a doubly-linked list other than a first entry and a last entry indicates a next entry in the doubly-linked list and a preceding entry in the doubly-linked list, and wherein removing the entry representing the given interrupt comprises updating the next entry in the doubly-linked list to point to the entry preceding the entry that was removed from the doubly-linked list.

This allows an entry to be removed from a doubly-linked list, such that the list structure and ordering is maintained.

In some examples, the one or more hardware-managed linked list data structures are stored in shared memory.

Hence, while the head and tail pointers (if provided) may be provided in storage circuitry within the apparatus, and while the linked lists are managed by the hardware of the interrupt circuitry, the linked list data structures themselves are—in this example—stored in a shared memory accessible (for example, via an interconnect) to the apparatus. The shared memory may also be accessible to one or more processors, including processors which are responsible for handling the pending interrupts. Note that, if the format of this hardware-managed linked list data structure is standardized across physical machines, this supports writing the structures on one machine and reading them on a different machine.

Storing the hardware-managed linked list data structures in memory reduces the circuit area required to implement the apparatus (since the amount of storage space needed within the apparatus can be reduced compared with the amount that would be needed if the linked lists were stored locally).

In some examples, the interrupt tracking circuitry is configured to manage one or more interrupt tracking tables in the shared memory to represent the one or more hardware-managed linked list data structures. In such examples, each interrupt tracking table comprises an entry for each of a plurality of interrupts, and the interrupt tracking circuitry is configured to manage the one or more hardware-managed linked list data structures by setting, in each entry of a given interrupt tracking table representing a pending interrupt to be tracked other than a last entry, a pointer to a next entry in a given hardware-managed linked list data structure.

In this example, the linked lists are represented in memory using interrupt tracking tables (also referred to herein as interrupt state tables (ISTs)). Each interrupt tracking table may comprise a plurality of entries, each entry representing an interrupt (e.g. each entry may indicate the interrupt identifier of an interrupt), and providing information about that interrupt (e.g. including whether or not that interrupt is pending and enabled). The one or more linked lists are then represented by updating entries in the interrupt tracking table(s)—for example, an entry may be updated to include a pointer to a next entry in the list. The linked list(s) thus provide an indication of an order of pending interrupts represented in the one or more interrupt tracking tables.

Using interrupt tracking tables in this way reduces the number of memory accesses that need to be performed to update a linked list, since it is possible to update existing entries in a table rather than writing new entries to a list. In addition, the use of interrupt tracking tables means that the storage required to manage the linked list(s) naturally scales with the number of interrupts required

In some examples, the interrupt tracking circuitry is configured to manage a plurality of interrupt tracking tables to represent the one or more hardware-managed linked list data structures, and the interrupt tracking circuitry is configured to set, in each entry of a given interrupt tracking table representing a pending interrupt to be tracked, a table identifier to identify which of the plurality of interrupt tracking tables contains the next entry in the given hardware-managed linked list data structure.

By setting a table identifier in each entry of a linked list, it is possible for a given linked list to span (e.g. comprise entries represented in) multiple interrupt tracking tables, allowing an order associated with interrupts in multiple tables to be tracked in a single linked list.

In some examples, each of the plurality of interrupt tracking tables represents a different class of interrupts.

Hence, in this example, providing table identifiers in entries of a given linked list can allow the linked list to indicate the sequence in which interrupts of multiple classes are to be processed relative to each other. The way in which interrupts may be classified may depend on the particular implementation, but in some examples interrupts may be classed as either private to a given processor or shared between multiple processors.

In some examples, a system is provided which comprises the apparatus described in any of the above examples, as well as interconnect circuitry (also referred to herein as an interconnect) coupled to the apparatus, and at least one processing element coupled to the interconnect circuitry.

The at least one processing element may comprise one or more processors responsible for handling pending interrupts detected by the apparatus. Also, one or more processing elements may execute software to provide a virtual processor, which also may be responsible for handling some or all of the pending interrupts. The one or more processing elements (PEs) and the apparatus may be arranged to communicate via an interconnect (interconnect circuitry), via which they may also have access to shared memory.

In some examples, at least one of the interrupt tracking circuitry and the at least one processing element is configured to identify a next highest priority pending interrupt by identifying a highest-priority linked list data structure which contains at least one entry corresponding to a pending interrupt, and identifying a next entry in that hardware linked list data structure.

Hence, the provision of one or more hardware-managed linked list data structures can provide a simple mechanism for determining a next highest priority pending interrupt to be handled by a particular processing element.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may embody computer-readable representations of one or more netlists. The one or more netlists may be generated by applying one or more logic synthesis processes to an RTL representation. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept. Some specific examples will now be described with reference to the drawings. It will be appreciated that the claimed subject-matter is not limited to these particular examples.

FIG. 1 schematically illustrates an example of a data processing system 2 (e.g. a system on chip) in which the present technique may be implemented. The data processing system 2 comprises a number of processing elements (PEs) 4 (e.g. processing circuitry such as central processing units, CPUs—processing circuitry may also be referred to as a “processor”). In this example three processors 4 are shown, but it will be appreciated that the number of processors could vary. The processors communicate with each other and with shared memory 8 via a cache coherent interconnect 6 which supports a coherency protocol to maintain cache coherency of data cached in private caches of each processor 4.

An interrupt controller 10 is provided, to receive incoming interrupt signals from connected peripherals 14 (which are hence examples of interrupt sources) and forward them to the processors 4. In some cases, processors also generate interrupts for other processors known as Inter-Processor Interrupts (IPIs), so the processors 4 themselves can also act as interrupt sources. Peripherals can signal interrupts to the interrupt controller 10 either via dedicated wires 11 or by reusing an existing I/O (input/output) mechanism 12 such as memory-mapped I/O write operations. The latter is typically known as message-signalled interrupts (MSIs). The job of the interrupt controller is to prioritize interrupts according to a configuration performed by software, to ensure that a higher priority interrupt is presented to processors in preference to lower priority interrupts. On modern multi-processor systems, with more than a single processor, the interrupt controller may also have to route interrupts to one or more specified processors and handle re-programming of the routing configuration without losing interrupt signals.

The interrupt controller therefore needs to be able to communicate with the processors to which it can forward interrupts. As shown in FIG. 1, one way to implement this is to use a dedicated communication protocol and interrupt communications bus 16 in the system, which is specifically designed to carry interrupt signals from the interrupt controller 10 to the processors 4. The interrupt communications bus 16 is entirely separate from the cache coherent interconnect 6 used to convey memory transactions between the processors 4, memory 8 and interrupt controller 10 (the interrupt controller 10 may still have an interface to the cache coherent interconnect 6 to allow memory transactions issued by the processors 4 to program the configuration information which controls how the interrupt controller 10 handles forwarding of interrupts to the processors 4).

Alternatively, the interrupt controller may send an “interrupt happened” signal to a processor over the bus, to prompt software executing on the processor to read interrupt tracking structures in memory to determine which interrupt is pending. This can reduce the number of bits that need to be provided in the bus, since it may not be necessary to identify information such as the type of a given interrupt when sending the “interrupt happened” signal. Moreover, even when interrupts are signaled over an interrupt bus, interrupt tracking structures may still be provided in the shared memory 8, which can (for example) be queried by software to determine which interrupts are pending and enabled. These interrupt tracking structures are, in the present technique, implemented as hardware-managed linked list data structures.

While a dedicated interrupt communications bus 16 and protocol are provided in the example of FIG. 1, this is just one option for signalling interrupts to processors. However, this approach can require significant design effort, especially in large distributed systems and for multi-socket implementations. FIG. 2 shows another way of implementing a data processing system 18 in which the present technique may be provided. In this example, a dedicated interrupt bus is not necessary, as the existing cache coherency mechanism supported by the cache coherent interconnect 6 is leveraged for distribution of interrupts from the interrupt controller 10 to the processor 4, and the interrupt configuration and state are represented by memory-based tables 20 which are shared by the processors 4 and the interrupt controller 10. By storing the interrupt tracking data structures 20 in memory and using the cache coherency protocol of the cache coherent interconnect 6 to ensure consistency between the view of the shared tracking data structures seen by the interrupt controller 10 and the processors 4, this means that when an interrupt changes state as a result of a message or signal received by the interrupt controller 10, then the interrupt controller can cause the interrupt to be delivered to the correct processor by simply updating the tracking data structures stored in memory. This can be done without the need of a dedicated interrupt bus 16 by using the existing cache coherency interconnect mechanisms supported by the interconnect 6. This greatly reduces the design effort involved in scaling the chip design to different numbers of processors and interrupts, since the scaling can be implemented by changing the size or number of structures of the data stored in memory, rather than needing to expand the wiring of a dedicated interrupt distribution bus 16.

As in FIG. 1, the system 18 includes at least one processor 4, the interrupt controller 10, the cache coherent interconnect 6 and the memory 8. While FIG. 2 shows only a single processor 4 for conciseness, additional processors may be provided and may operate in the same way as the processor 4 shown in FIG. 2.

A given processor 4 includes processing circuitry 22 for performing data processing operations in response to instructions. For example, the processing circuitry 22 may include a processing pipeline with pipeline stages for fetching, decoding, and executing instructions. Any known pipeline design may be used for the processor 4. The processor 4 also includes processor memory access circuitry 26, which acts as the interface between the processor 4 and the cache coherent interconnect 6 and is responsible for issuing memory access requests and receiving responses to memory access requests, as well as receiving/issuing other messages according to the coherency protocol operated by the cache coherent interconnect 6, such as snoop requests and responses.

The data processing system 18 also includes an interrupt controller 10, which includes interrupt detection circuitry 40 to detect interrupts raised by interrupt sources such as processors 4 or peripherals 14 (although not shown explicitly in FIG. 2, as in FIG. 1 the interrupts could be detected using dedicated interrupt wiring 11 or with a message based approach where interrupts are signalled in-band in the memory transactions sent by peripheral devices for accessing the memory system 8). Interrupt tracking circuitry 44 responds to the detection of a given interrupt by the interrupt detection circuitry 40 to control the tracking of pending interrupts using the interrupt tracking table(s) 20 in memory and pointers stored in pointer storage circuitry 48 provided in the interrupt tracking circuitry 44. Interrupt controller memory access circuitry 46 is provided to control access to the memory system for the interrupt controller 10 and to manage the exchange of cache coherency messages between the interrupt controller 10 and the cache coherent interconnect 6.

The one or more interrupt tracking tables 20 provided in the shared memory 8 are arrays of data indicating the pending and enabled states of each of a plurality of interrupts. When the interrupt control circuitry 44 detects a given enabled interrupt raised by an interrupt source, it signals the given enabled interrupt to a given processor by controlling the interrupt controller memory access circuitry 46 to issue one or more memory write requests to update the interrupt tracking tables corresponding to the target interrupt handling context in which the interrupt is to be processed—for example, these write requests may cause the pending and/or enabled state of the given interrupt to be updated in the tables.

In accordance with the present technique, the interrupt tracking circuitry 44 tracks pending, enabled interrupts detected by the interrupt detection circuitry 40 by maintaining one or more hardware-managed linked list data structures. A linked list is a list of items in which each entry other than the last entry includes a “next” pointer to the next entry in the list. In the system 18 shown in FIG. 2, the entries in the linked lists are represented in the one or more interrupt tracking tables 20. In particular, each entry in the interrupt tracking tables which is also in a linked list will include a next pointer, as described above. This allows an order of the pending and enabled interrupts to be tracked.

In addition to controlling the interrupt controller memory access circuitry 46 to issue write requests to update entries in the interrupt tracking tables 20, the interrupt tracking circuitry 44 also updates the pointers stored in the pointer storage circuitry 48. These pointers indicate the head (first) and tail (last) entries of each linked list maintained by the interrupt tracking circuitry 44.

As noted above, separate interrupt tracking structures may be provided for different interrupt handling contexts. Each interrupt handling context could be either a physical processor 4 implemented in hardware within the system, or a virtual processor which is software executing on a physical processor 4 to emulate the behaviour of a different processor. At any one time, a given physical processor 4 may be executing one active virtual processor (referred to as the “resident” virtual processor) but there may also be a number of inactive virtual processors which are awaiting slot of execution on a physical processor (these inactive virtual processors may be referred to as “non-resident” virtual processors). Each interrupt handling context may have a corresponding set of memory-based interrupt tracking structures.

FIG. 3 shows an example of how updates to a linked list data structure may be managed, using head and tail pointers in pointer storage circuitry and at least one interrupt tracking table. Note that while the linked list data structures themselves may be stored in general memory storage which can also be used for other data, and storage of the linked lists in the memory can depend on address allocations managed by software, updates to the linked list data structures of the present technique are managed in hardware, and hence are performed without explicit software direction.

As shown in FIG. 3, an interrupt tracking table 20—also referred to herein as an interrupt state table (IST)—comprises a plurality of entries (each labelled ISTE in FIG. 3). A subset of the entries in the IST form part of a set of hardware-managed linked lists, as shown by arrows (the arrows connect adjacent entries in a given linked list). In particular, FIG. 3 illustrates a doubly-linked list, in which each entry (other than the first and last entries) includes both a “previous” pointer to the preceding entry in the list and a “next” pointer to the next entry in the list (note that the next and previous pointers are not shown in FIG. 3). Hence, the order of the entries in a given linked list can be determined by traversing the list in either direction using the next or previous pointers.

FIG. 3 also shows an example of pointer storage circuitry 48. In this example, the pointer storage circuitry comprises a set of pointers for each of a plurality of PEs (e.g. PE 0 and PE 1) as well as a set of pointers for “1 of N” interrupts (e.g. interrupts which are to be dealt with by any one of a given list of PEs).

For each linked list, the pointer storage circuitry stores a head pointer 50 and a tail pointer 52—the head pointer 50 is a pointer to the first/next entry in that linked list, while the tail pointer 52 is a pointer to the last entry in the list.

As shown in FIG. 3, multiple linked lists may be maintained by the interrupt tracking circuitry. In this particular example, for each PE (and for 1 of N interrupts), a linked list is maintained for each priority level (Priority 0, Priority 1, etc. . . . ). The HPPI can thus be determined by reading the head pointer for the highest priority level (e.g. Priority 0). If this head pointer indicates that the associated list is empty, the head pointer for the next-highest-priority pending interrupt can be read, and so on. Providing a separate linked list for each priority level is advantageous, because it simplifies inserting of a new interrupt into the lists—for example, if an interrupt with priority 1 becomes pending and enabled, it can simply be inserted into a given location (e.g. at the tail) in the corresponding list. In contrast, if one provided a single linked list in priority order, inserting a new interrupt would involve searching through the list to find the appropriate location to insert the interrupt.

FIG. 4 shows another example of how a linked list data structure may be maintained using ISTs. In particular, FIG. 4 shows how a single linked list can span multiple ISTs. To facilitate this, each pointer in entries of the ISTs (e.g. each previous pointer and each next pointer), and each pointer in the pointer storage circuitry, includes a table identifier (Table ID) indicating the IST in which the corresponding entry is stored.

As shown in FIG. 4, a separate IST 20 may be provided for each class of interrupts. Hence, providing a Table ID in each pointer allows a given linked list to span multiple tables, which in turn allows interrupts from different classes to be tracked in the same linked list. This avoids the need to check multiple linked lists (e.g. if a separate linked list was provided for each class) to determine which interrupt is the next to be dealt with.

FIG. 5 shows an example of an IST entry 54. In this example, each IST entry 54 contains an interrupt identifier (INTID) 56 of a particular interrupt, a field holding a previous (PREV) pointer 58 to the preceding entry in a linked list and a field holding a next (NXT) pointer 60 to the next entry in a linked list. In this example, the IST entry 54 is compatible with a doubly-linked list data structure (because it provides fields for identifying a previous entry as well as a next entry); however, in other implementations it is possible for only the next pointer to be provided (i.e. for the previous pointer to be omitted), providing a singly-linked list.

In this example, each of the PREV and NXT pointers comprises an INTID 62, 64 to identify the previous/next entry, and a table identifier (TAB ID) 66, 68 to indicate the IST in which the previous/next entry is found. This allows a linked list to traverse multiple ISTs as discussed above. It will be appreciated that in implementations where the linked lists are not required to traverse multiple tables, the table identifiers 66, 68 can be omitted.

As explained above, the linked list data structures used to track pending interrupts can be either doubly-linked (where each entry other than the first and last entries specifies both a previous entry and a next entry) or singly-linked (where each entry other than the last entry specifies a next entry but not a previous entry). The structure of a singly-linked list makes it possible to easily find the next interrupt to service at a given priority; however, removing an entry involves traversing the list from the start to find the entry before the deleted entry so that its pointer can be updated.

Note that, while the interrupt identifier (INTID) 56 for the IST entry 54 itself is shown explicitly in the example of FIG. 5, this is just one option. In an alternative example, the interrupt identifier for the entry itself is not actually contained in the IST entry, because it is implicit based on the location of the entry in the table. So, for example, the IST entries could instead look like this:
entry0: [prev INTID,V], [data0], [next INTID,V]
entry1: [prev INTID,V], [data1], next INTID,V]
. . .

In this example, the interrupt identifier of entry 0 would be 0, but that identifier is not part of [data0] because any agent accessing this entry already knows it is operating on INTID0. Instead, [datax] contains metadata and state about the interrupt, e.g. priority, mask, level/edge configuration bit, and/or PE target of the interrupt.

FIG. 6 shows an example of why a doubly-linked list data structure can be particularly advantageous. In particular, FIG. 6 shows the steps involved in removing an entry from a doubly-linked list. As shown, the doubly-linked list includes a first entry 54a for an interrupt with identifier INT0 56a, a second entry 54b for an interrupt with identifier INT1 56b, and a third entry 54c for an interrupt with identifier INT2 56c. Since the entries shown in FIG. 6 form part of a doubly-linked list, each entry specifies both a PREV pointer 58 and a NXT pointer 60: in the entry 54a for INT0, the NXT pointer 60a identifies INT1 (indicating that the next entry is the entry 54b for INT1); in the entry 54b for INT1, the PREV pointer 58b identifies INT0 and the NXT pointer 60b identifies INT2; and in the entry 54c for INT2, the PREV pointer 58c identifies INT1. The entry 54a for INT0 and the entry 54c for INT2 also include PREV and NXT pointers 58a, 60c respectively, but the contents of these pointers are shown as they are not relevant to this discussion.

FIG. 6 illustrates a process of removing, from a doubly-linked list, the entry for interrupt INT1. As shown in “B”, this process involves disabling the entry for INT1—for example, the entry 54b for INT1 could be updated to store some state indicating that it is disabled. Then, as shown in C, the PREV and NXT pointers 58, 60 of the preceding and following entries 54a, 54c are updated to point to each other—the NXT pointer 60a in the entry for INT0 now identifies INT2, and the PREV pointer 58c in the entry for INT2 now identifies INT0. Hence, the entry for INT1 has been removed.

FIG. 6 also illustrates an advantage of the linked list being doubly-linked. In particular, as shown in B, a doubly-linked list can be “healed” after an entry is removed, without needing to traverse the list from the start to identify the entry preceding the entry being removed. For example, since both the NXT pointer 60a of the entry 54a for INT0 and the PREV pointer 58c of the entry 54c for INT2 identify INT1, it is possible to identify that—since INT1 has been disabled/is no longer being tracked—the next entry after the entry 54a for INT0 is the entry 54c for INT2. Hence, it is still possible to traverse the list between the removal of INT1 and the updating of the PREV and NXT pointers.

Turning now to the flow diagrams, FIG. 7 shows an example of a method of tracking pending interrupts—this method may, for example, be performed by the interrupt controller described above.

In the method of FIG. 7, when a pending interrupt is either detected 62 and determined 66 to be enabled, or when a previously disabled interrupt is enabled 64, the method comprises locating 68, in pointer storage circuitry, the pointers for a corresponding linked list data structure. For example, the corresponding linked list could depend on a priority level of the interrupt. Note that if an interrupt is detected 62 but determined 66 to not be enabled, it is not tracked (as shown in step 70) unless and until it has been enabled in step 64.

For an interrupt that is to be tracked (e.g. a pending, enabled interrupt), the method also includes determining 72 whether the corresponding linked list (as discussed above) is empty (i.e. does not contain any entries). If the linked list is empty, the head and tail pointers are updated 74, 76 to add INTID to the list. In this scenario, INTID would be the only entry in the list, and hence its previous and next pointers need not be updated.

If, on the other hand, it is determined 72 that the corresponding linked list is not empty, the tail pointer for the list is read 78 to identify the entry which is currently in the last position in the list. The PREV pointer for INTID (i.e. the new interrupt to be tracked) in the IST can then be set 80 to point to the entry that is currently identified by the tail pointer, and the NXT pointer for the entry currently identified by the tail pointer can be updated 82 to point to INTID. The tail pointer is also updated 76 to identify INTID.

In this way, a new pending interrupt can be added to a doubly-linked list data structure. Moreover, it will be appreciated that this method is also applicable to a singly-linked list, with the only difference being that step 80 can be omitted.

FIG. 8 illustrates a method for identifying the highest priority pending interrupt (HPPI) using hardware-managed linked list data structures. This method could, for example, be performed by the interrupt controller, by one of the PEs described above, or by software executing on one of the PEs. The method assumes that a separate linked list is managed for each priority level, where priority level 0 is the highest priority level, where a “higher” priority interrupt pre-empts a “lower” priority interrupt. For example, a higher priority interrupt may be an interrupt that is considered more important than a lower priority interrupt, and a higher priority interrupt may be permitted to interrupt processing of a lower priority interrupt, but not the other way around. It will be appreciated, however, that the labelling of priority levels is not particularly limited—for example, other implementations may label the lowest priority level as priority level 0.

The method includes a step 84 of reading the head pointer for the priority level 0 linked list. If 86 the head pointer indicates that the linked list is empty, the head pointer for the linked list at the next priority level (e.g. priority level 1) is read 88. Steps 86 and 88 are then repeated until a head pointer is read that does not indicate that its corresponding linked list is empty. This allows the highest-priority non-empty linked list to be identified.

Once the highest-priority non-empty linked list is identified, the method includes determining 90 that the interrupt identified by the head pointer is the HPPI. Then, assuming that the HPPI is being identified so that it can be resolved by a PE, the method involves a step 92 of triggering—once the interrupt is taken—an update to the head pointer so that it points to the next interrupt in the linked list (i.e. to remove the interrupt that is being resolved by the PE from the list). Note that step 92 is optional—there can be various reasons at the PE why, even though the interrupt is identified as the HPPI, it does not end up being taken, in which case the head pointer of the list would not be updated.

Hence, FIG. 8 shows the ease with which the HPPI can be identified when the present technique is implemented. In particular, the HPPI can be identified simply be reading one or more head pointers in pointer storage circuitry, without needing to scan an entire IST (or multiple ISTs).

FIG. 9 shows a method for removing an interrupt from a doubly-linked list data structure. As shown, the method involves determining 94 that a given interrupt INTID is no longer pending and enabled—for example, the interrupt source may have de-asserted the interrupt signal, or the interrupt may have been disabled.

When it is determined that INTID is no longer pending and enabled, the method includes a step 96 of locating INTID in the IST, and updating that entry to indicate that INTID is no longer pending or is disabled. The method also includes locating 98 the previous entry in the list using the PREV pointer of the entry for INTID, and updating 100 the NXT pointer of the identified entry to point to the entry following that for INTID. Similarly, the method includes steps of locating 102 the next entry in the list (i.e. the entry following INTID) and updating 104 its PREV pointer.

Accordingly, FIG. 9 demonstrates how the use of a doubly-linked list makes it particularly straight-forward to remove an entry from the list, since the PREV pointer in the entry to be removed allows the preceding entry, which needs to be updated, to be identified.

As shown in the examples above, using one or more hardware-managed linked list data structures to track pending interrupts is advantageous, because it avoids the need to scan large arrays of data in memory to identify the HPPI, or to update the pending and enabled states of interrupts. These advantages are provided when either a singly-linked list or a doubly-linked is used, but the above examples also show that using a doubly-linked list is especially advantageous, because it simplifies the updating of the list following removal of an entry.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Further, the words “comprising at least one of . . . ” in the present application are used to mean that any one of the following options or any combination of the following options is included. For example, “at least one of: A; B and C” is intended to mean A or B or C or any combination of A, B and C (e.g. A and B or A and C or B and C).

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
interrupt detection circuitry to detect interrupts raised by at least one interrupt source; and
interrupt tracking circuitry to manage one or more hardware-managed linked list data structures to track pending interrupts detected by the interrupt detection circuitry.

2. The apparatus of claim 1, wherein
the interrupt tracking circuitry comprises pointer storage circuitry to store, for each of at least a subset of the one or more hardware-managed linked list data structures, a head pointer indicative of a first entry in the hardware-managed linked list data structure and a tail pointer indicative of a last entry in the hardware-managed linked list data structure.

3. The apparatus of claim 1, wherein:
the one or more hardware-managed linked list data structures comprise at least one physical interrupt linked list to track physical interrupts and at least one virtual interrupt linked list to track virtual interrupts; and
the interrupt tracking circuitry comprises memory access circuitry to maintain, in a memory accessible to the interrupt controller, a pointer data structure to store, for each of the at least one virtual interrupt linked list, a head pointer indicative of a first entry in the hardware-managed linked list data structure and a tail pointer indicative of a last entry in the hardware-managed linked list data structure.

4. The apparatus of claim 2, wherein
the interrupt tracking circuitry is responsive to identifying a given interrupt to be tracked to:
update a next entry pointer in the last entry in a given hardware-managed linked list data structure to point to an entry corresponding to the given interrupt; and update the tail pointer for the given one of the one or more hardware-managed linked list data structures to indicate the entry corresponding to the given interrupt.

5. The apparatus of claim 2, wherein
the pointer storage circuitry is configured to store, as the head pointer for each of the one or more hardware-managed linked list data structures, an interrupt identifier associated with an interrupt represented by the first entry of the hardware-managed linked list data structure and to store, as the tail pointer for each of the one or more hardware-managed linked list data structures, an interrupt identifier associated with an interrupt represented by the last entry of the hardware-managed linked list data structure.

6. The apparatus of claim 1, wherein
the interrupt tracking circuitry is configured to:
identify one of a plurality of priority levels associated with each pending interrupt; and
manage, for each of the plurality of priority levels, a corresponding hardware-managed linked list data structure to track pending interrupts associated with that priority level.

7. The apparatus of claim 1, wherein
the interrupt tracking circuitry is configured to identify, in each entry of a given hardware-managed linked list data structure other than a last entry, a next entry in the given hardware-managed linked list data structure.

8. The apparatus of claim 7, wherein
the interrupt tracking circuitry is configured to manage the one or more hardware-managed linked list data structures as doubly-linked lists, wherein each entry in a given hardware-managed linked list data structure other than a first entry and a last entry indicates the next entry in the hardware-managed linked list data structure and the preceding entry in the hardware-managed linked list data structure.

9. The apparatus of claim 7, wherein
the interrupt tracking circuitry is responsive to determining that a given interrupt is no longer pending to remove, from the one or more hardware-managed linked list data structures, an entry representing the given interrupt, wherein removing the entry representing the given interrupt comprises updating the preceding entry in the hardware-managed linked list data structure to point to the entry following the entry that was removed from the hardware-managed linked list data structure.

10. The apparatus of claim 9, wherein:
the interrupt tracking circuitry is configured to manage the one or more hardware-managed linked list data structures as doubly linked lists, wherein each entry in a doubly-linked list other than a first entry and a last entry indicates a next entry in the doubly-linked list and a preceding entry in the doubly-linked list; and
removing the entry representing the given interrupt comprises updating the next entry in the doubly-linked list to point to the entry preceding the entry that was removed from the doubly-linked list.

11. The apparatus of claim 1, wherein
the one or more hardware-managed linked list data structures are stored in shared memory.

12. The apparatus of claim 11, wherein:
the interrupt tracking circuitry is configured to manage one or more interrupt tracking tables in the shared memory to represent the one or more hardware-managed linked list data structures; and
each interrupt tracking table comprises an entry for each of a plurality of interrupts, and the interrupt tracking circuitry is configured to manage the one or more hardware-managed linked list data structures by setting, in each entry of a given interrupt tracking table representing a pending interrupt to be tracked other than a last entry, a pointer to a next entry in a given hardware-managed linked list data structure.

13. The apparatus of claim 1, wherein:
the interrupt tracking circuitry is configured to manage a plurality of interrupt tracking tables to represent the one or more hardware-managed linked list data structures; and
the interrupt tracking circuitry is configured to set, in each entry of a given interrupt tracking table representing a pending interrupt to be tracked, a table identifier to identify which of the plurality of interrupt tracking tables contains the next entry in the given hardware-managed linked list data structure.

14. The apparatus of claim 13, wherein:
each of the plurality of interrupt tracking tables represents a different class of interrupts.

15. A system comprising:
the apparatus of claim 1;
interconnect circuitry coupled to the apparatus; and
at least one processing element coupled to the interconnect circuitry.

16. The system of claim 15, wherein
at least one of the interrupt tracking circuitry and the at least one processing element is configured to identify a next highest priority pending interrupt by:
identifying a highest-priority linked list data structure which contains at least one entry corresponding to a pending interrupt; and
identifying a next entry in that hardware linked list data structure.

17. A method comprising:
detecting, using the interrupt detection circuitry, interrupts raised by at least one interrupt source; and
managing, in hardware, one or more linked list data structures to track pending interrupts detected by the interrupt detection circuitry.

18. A computer program comprising computer-readable code for fabrication of an apparatus comprising:
interrupt detection circuitry to detect interrupts raised by at least one interrupt source; and
interrupt tracking circuitry to manage one or more hardware-managed linked list data structures to track pending interrupts detected by the interrupt detection circuitry.

19. A computer-readable storage medium to store the computer program of claim 18.
